(19) United States
(12) Patent Application Publication
(10) Pub. No.: US 2015/0325132 A1
(43) Pub. Date: Nov. 12, 2015

(54) METHOD AND SYSTEM OF ACTIVITY SELECTION FOR EARLY CHILDHOOD DEVELOPMENT

(71) Applicant: KINEDU, S.A.P.I. de C.V., San Pedro Garza Garcia (MX)

(72) Inventors: Luis Garza Sada, San Pedro Garza Garcia (MX); Eugenia González Rodriguez, Boston, MA (US); Guillermo Andres Farias Martinez, San Pedro Garza Garcia (MX)

(73) Assignee: KINEDU, S.A.P.I. de C.V., San Pedro Garza Garcia (MX)

(21) Appl. No.: 14/271,715

(22) Filed: May 7, 2014

(51) Int. Cl. G09B 7/00; G09B 5/06; G09B 19/00

(52) U.S. Cl. CPC G09B 7/00; G09B 19/00; G09B 5/065

(57) ABSTRACT

A method and system for evaluating child development activities for a preschool child. The evaluation may include scoring activities to be performed by or with the child based on a target age for the preschool child. The assessment of the preschool child's abilities and behaviors may be compared with expected levels of performance represented by development milestones. The system may include a non-transitory computer-readable medium that, when executed by a processor, will perform the method.

### BACKGROUND OF THE DISCLOSURE

1. Field of the Disclosure

This disclosure generally relates to the field of early childhood development, and, in particular, providing direction to caregivers in the selection of child development activities to enhance early childhood development.

2. Description of the Art

Child development is recognized as integral to the maintenance of prosperous family and social structures. During their early years, children undergo rapid brain development, especially between birth and about 66 months. The brain connections formed during this period of rapid development form the basis of learning and personality for the rest of their lives.

Brain architecture is influenced by genetic design, environmental factors, and the experiences through which the child goes in his or her early years. During the first few years of life, 700 new neural connections are formed every second. After formation, some of these connections are reduced through a process called “pruning” as the brain is streamlined. This combination of building connections and pruning for efficiency is key to building complex brain circuits that form the basis for learning, cognitive processes, executive functions, and behavior. This process is ongoing throughout life and reaches full maturation well into adulthood. (See INBRIEF: The Science of Early Childhood Development, Center on the Developing Child, Harvard University).

Reinforcement of desirable learning behaviors may enhance and direct the process of “pruning” in the developing brain. By keeping parents better informed as to the abilities and interests of their child during the stages of childhood development, parents can be better equipped to present their child with a stimulating learning environment that will enhance their later brain development and fill gaps in the preschool child's curriculum or address specific areas of study.

### Developmental Standards for Children

Early childhood development is often broken down into stages that are common for most children as they progress from birth to their preschool years. Herein, the term “preschool child” will refer to a child with a chronological age in the range between birth and about 66 months. These stages are often represented by chronological ages or age ranges. Progression through these stages or levels is measurable through observation and testing. Data on the skills, activities, and behaviors of children during early development has been used to establish norms and performance standards for children at each chronological age level. Thus, the list of characteristic skills and behaviors may be associated with a three-year-old child that is different from the list of abilities and behaviors associated with an 18-month-old child.

The developmental level of a preschool child is commonly associated with the activities and behaviors in which the preschool child has demonstrated performance. These activities may include learned activities that include experiential learning activities, play activities, and lessons. The list of activities and behaviors used as criteria in assessing developmental progress and the activities suggested in promoting development may be obtained from a number of sources. These sources may be governmental (educational testing requirements and statistical norms) or professional (recommendations from medical associations specializing in preschool child development). The list of activities and behaviors may include entries derived from one or more of the Infant-Preschool Play Assessment Scale (I-PAS) developed by Sally Flagler, Ph.D., the American Academy of Pediatrics (AAP) developmental milestones, the National Association for the Education of Young Children (NAEYC) and the National Association of Early Childhood Specialists in State Departments of Education (NAECS/SDE) GUIDELINES FOR CURRICULUM CONTENT and GUIDELINES FOR APPROPRIATE ASSESSMENT FOR PLANNING INSTRUCTION AND COMMUNICATING WITH PARENTS, the Head Start Child Outcomes Framework, the Mexican Health Ministry (MHM), the Centers for Disease Control (CDC), and other government or educational organization criteria, standards; benchmarks, guidelines, or indicators.

By establishing a list of child developmental milestones that may be demonstrated by the preschool child, one preschool child may be compared with others. Child developmental milestones may include skills, whether in the form of observable behaviors or performed activities, in which a preschool child is expected to demonstrate mastery at some point during their development. When the same child developmental milestones are used on each and every preschool child of a group, then each preschool child may be compared based on their individual performance against the performance of the group in order to determine the preschool child's developmental level relative to the group. In some instances, an individual preschool child may then be associated with peers at the same or similar developmental level based on the developmental standards within a class, a school, or other educational organization. In other cases, the preschool child may receive additional educational support to bring the preschool child up to the developmental level of their class or group members.

Progress of the preschool children may also be determined based on performance against government or professional established standards. Appropriate learning activities or behaviors for the group or class may be determined based on an indication of progress demonstrated by the preschool children of the group or class with respect to the set of government standards, professional standards, and group of class performance. The progress may be assessed across several developmental areas that are used to characterize the developmental levels of preschool children. Since preschool children demonstrate a highly varied set of skills and behaviors, it is common for preschool children to express themselves with proficiencies in some developmental areas while suffering from deficiencies in other developmental areas.

### Preschool Child Development Areas

The developmental areas of preschool children may be divided into several categories to separate characteristics that may develop semi-independently as the preschool child grows. It is common to divide early childhood development into areas, such as, cognitive, linguistic, social/emotional, and physical skills.

Cognitive skills relate to what a preschool child knows and understands. Cognitive skills may include physical knowledge (for example colors, shapes, objects) and abstract knowledge (for example spatial reasoning, pattern recognition, approaches to learning, and cause and effect relationships). In most cases, the ability to integrate knowledge and develop conceptual understanding can only be learned through exploration and sensory experience. Cognitive skill development may be encouraged by providing preschool children with frequent, wide-ranging opportunities to explore and experience their environment. Cognitive skills may be estimated based on how long it takes to complete an activity or how many attempts/failures were committed when compared with how long it takes to complete an activity (speed and reaction time to stimulus) or how many trials/errors were committed (accuracy) for a preschool child at a similar chronological or developmental age. Cognitive skill may also be measured based on whether the preschool child is able to recognize images of animals, numbers, letters, items, musical concepts, etc.

Linguistic (or language) skills include listening comprehension, vocabulary, reading comprehension, and speaking. Literacy and the ability to communicate are heavily dependent on linguistic skills. Linguistic skill performance is critical for the preschool child to develop the ability to communicate wants, needs, and ideas. Exposure to and involvement in conversations, following verbal instructions, targeted vocabulary learning, and encouragement to speak all contribute to the development of linguistic skills.

Social/Emotional skills relate to a preschool child's ability to conduct themselves in social situations and to manage their internal emotions. Social/emotional skills include paying attention, transitioning from one activity to the next, cooperating with other preschool children, expressing feelings, showing empathy, and sharing. Social/Emotional skills eventually mature to form “executive functions”—which allows the individual to make decisions effectively, control impulses, and overall, relate to others.

Physical (motor) skills relate to the physical movement of the body and a preschool child's ability to control these movements. Physical skills may relate to control of strength and coordination of movement. Physical skills may be divided into two types: gross motor (such as whole body, large muscle movements) and, fine motor (manipulation with hands, and hand-eye coordination). Physical skills may be developed through exercises geared to have the preschool child move their body relative to objects and the use their body to manipulate objects. Instructions regarding physical activities may be given 1) directly to the preschool child by a parent or device or 2) indirectly to the preschool child by the device through the parent.

Development standards may provide guidance as to what abilities and behaviors should be expected of or mastered by each preschool child in at a particular development level. The activities and behaviors may include, for example, skills, abilities, aptitudes, and actions that a preschool child can display, learn, or develop or be expected to display, learn, or develop over time. Some of the activities and behaviors may be associated multiple developmental areas.

### Estimating the Developmental Levels of Preschool Children

Generally, the development level of a preschool child based on a comparison between the preschool child's performance on tests, participation in activities, and exhibition of behaviors relative to the similar qualities found in other preschool children at different stages of development. The standards used for comparison, as discussed above, may be expressed as tests or observations. At very young ages, such as baby and infant stages, a preschool child may be unable to participate in a formal test requiring preschool child interaction with a testing device, so the developmental level in each area may need to be assessed based on observations performed and reported by a caregiver. Herein, a “caregiver” for a preschool child is any person involved in overseeing or participating in the early development of a child, including, but not limited to, parents, grandparents, guardians, step parents, foster parents, preschool teachers, and, early childhood development professionals. The observations may be associated with developmental areas and expressions of abilities by the preschool child.

The estimating process for early childhood developmental levels may be divided into child developmental milestones (or milestones). A milestone represents a demarcation of a significant change or stage in development of a preschool child. A milestone may define a point where a preschool child transitions between being able or unable to perform an activity or demonstrate a behavior. A benefit of milestones, when relying on assessment based on observation of the preschool child, is that child developmental milestones require Boolean responses from the observer rather than a qualitative response that may be subjective or a numerical response which may vary based on the observer. The child developmental milestones are designed to be specific, easily identifiable, and objective, which reduces the variability of responses that may be received across different caregivers or observers.

Often a preschool child's peer group is made up of children of similar chronological age; however, in some cases, children may be grouped based on physical characteristics, such as height and weight, since the physical development age of a child may differ from the chronological age of the preschool child. Children may also be grouped based on performance on developmental tests. Chronological age and/or results of developmental testing may be used to provide information used to determine the expected developmental age of the preschool child. The e developmental age or level of the preschool child may be greater than or less than the chronological age of the preschool child. Across several developmental areas, a preschool child may perform a different levels, i.e. ahead in linguistic skills but behind in cognitive skills relative to the developmental level of other preschool children of the same chronological age.

### Assessment Techniques

Assessment techniques are used to determine the estimated developmental age of a preschool child relative to their test results, chronological age, and/or physical characteristics. Generally, assessment techniques may be observation based or interactive based.

Observation based assessment techniques involve watching or observing the performance or behavior of the preschool child. The preschool child may be observed by a caregiver and, the observations may be recorded or logged to form a record of the preschool child's performance of activities and behaviors. Observation based assessment does not involve the preschool child interacting with the observer.

Observation by a professional, such as an accredited early childhood development specialist or child psychologist has the advantage of formal training and professional experience with a number of preschool children. Since observation by a professional is limited to the times when the preschool child is under observation, often at the professional's office or other therapeutic setting, much of the preschool child's behavior may go unobserved (i.e. in the family or home settings). Also, the cost of professional observation may be more expensive that can be afforded by most parents.

Observation by a parent or guardian has the advantage of the high degree of direct observation time without a high cost. However, the parent or guardian is likely to be an untrained observer and may introduce more subjectivity into observations than would be introduced by an early childhood development professional.

Some parents may even make a record, such as pictures, visual recording, audio recording or other multimedia records, of the preschool child's performance to serve as documentation. Should a question arise as to the observations made by the parents or the parents simply want confirmation, this multimedia record may be recalled and assessed independently by a professional.

Interactive based assessment techniques involve the preschool child interacting with a person or device. The person may be a caregiver who is involving the preschool child in an activity, such as sounding out words, clapping, etc. The device may be a computer, learning tool, or other interactive machine configured provide the preschool child with feedback when manipulated by the preschool child. Exemplary interactive devices may display information on a screen that the preschool child may view or touch, or make a sound when a particular button is pressed. Some interactive devices contain a memory that will record the actions of the preschool child during an interactive session, such as duration of use, number of correct/incorrect answers, or the amount of time to perform an activity. Some interactive devices may be programmed to remind the parent that it is time for the preschool child to participate in an activity or time for the parent to record an observation about the preschool child's performance.

Interactive devices come in a large variety and serve as innovative, technology-based means to stimulate a preschool child and make learning fun and engaging. These interactive devices may include personal computers, computer tablets, mobile handheld devices, smartphones, gaming platforms, etc. Subjects covered through the use of the interactive devices may include simple touch-and-talk or matching exercises for very young children, to more complicated subjects such as math, reading, science, social studies, music, geography, and spelling. Interactive sessions may be conducted as formal teaching exercises or through informal exercises, such as through gameplay or entertainment.

Results from interactive sessions and observations may be stored in a database and compared with results of similar interactive sessions and observations of other preschool children. This allows for real-time comparisons between the performance of the preschool child and a general population of similar preschool children at similar ages can be provided to the parent and used in directing the development of the preschool child. The preschool child's progression through developmental levels may also be mapped against the progress of similar preschool children.

### Assessment Measures

Performance of the preschool child during the interactive sessions and observations may be assessed by a variety of measures. Examples of these measures may include duration of time to complete an activity, percentage of an activity performed correctly, and number of attempts at completing an activity. Time measurement may include the length of time that a preschool child remains engaged in an activity or behavior or may include the length of time that a preschool child used to accomplish a desired activity. A percentage of an activity performed correctly (or its inverse) may be used as a numerical measure of performance when the preschool child has to perform a series of (usually) independent activities.

Some of the multiple behaviors used to assess developmental progress may be correlated with respect to a set of government or organization standards. Progress of the preschool child with respect to the set of government or organization standards may be determined based on the determined ability of the preschool child to perform the multiple behaviors used to assess developmental progress. An appropriate learning activity or behavior may be determined based on the progress of the preschool child with respect to the set of government or organization standards.

### Tracking and Record Keeping

The preschool child's performance at activities and behaviors are usually kept and used to determine progress and trends in the preschool child's development. The progress of the preschool child relative to past performance or expectations based on standards may serve as an indicator of which developmental areas require additional work to enable the preschool child to perform at their expected developmental level.

Caregivers may be provided with reports that summarize the performance of the preschool child based on a series of assessment measures. These reports can alert the caregivers of the current developmental level of the preschool child. Comparing multiple reports may provide an indication of the progress of the preschool child in one or more developmental areas.

Records may be retained physically or electronically. Electronic recordkeeping allows for quick recall and distributed storage and backup of information. A system configured to record observations entered by educators or parents or track interactive activities with the preschool child may be used to determine the activities and behaviors that the preschool child is able to perform of how well the preschool child is able to perform the activities and behaviors. By determining which activities and behaviors the preschool child is able to perform and how well the preschool child is able to perform them, a system may be configured to assess and document the developmental progress of the preschool child, identify behaviors with which the preschool child needs improvement or those which the preschool child is ready to learn, provide the educators or parents with feedback that identifies the behaviors in which the preschool child needs improvement or those which the preschool child is ready to learn, and suggests activities that may be helpful in promoting development of skills needed to perform the identified behaviors. Some electronic record systems organize activities and behaviors by developmental areas.

Electronic systems may provide the advantage of quick recall of information and collation of data. An electronic system may provide online, observation-based, assessment and curricular resource to assist caregivers, educators, or others in assessing development progress of preschool children and planning activities that promote developmental progress.

The stored records may be used to assist caregivers, and other parties with an interest in a child's developmental progress, in assessing developmental progress of preschool children and planning activities to promote developmental progress of preschool children. Data indicative of the developmental age or level of each preschool child may be used in assessing the developmental level of each preschool child. Further, the aggregated data regarding developmental levels of many preschool children may be used to improve the overall learning experience for the population of preschool children at large.

### Recommendations for Caregivers

Tracking the performance of the preschool child allows the parents have a record of the preschool child's progress. Review of the tracked performance and observations allows the professional to provide suggested activities for the preschool child based on the preschool child's performance at a specific time or based on progress over a period of time. Sometimes caregivers may be presented with suggestions about activities to enhance early childhood development by a software based analysis of the preschool child's performance.

In U.S. Pat. Pub. No. 2012/0329025, a system is proposed that includes a hand held early childhood development assessment tool configured assess a preschool child's performance for comparison with expected performance for the preschool child based on chronological age. The hand held tool is designed to be manipulated by a preschool child and execute software that includes tests wherein the results designed to be indicative of the preschool child's skills in key developmental areas. The hand held tool allows observations and media generated by parents, such as images and videos of the preschool child, may also be uploaded to a server in communication with the hand held tool. The system uses data about the preschool child's performance to identify developmental areas where the preschool child is not performing at the expected level based on the preschool child's chronological age.

In U.S. Pat. Pub. No. 2009/0094540, a system is proposed that provides a portable software application configured for use by a preschool child on a portable computing device to determine the preschool child's capabilities in developmental areas. The system includes instructions and software for various activities to be performed by the preschool child and measured to provide an estimate of the child's developmental level. Measurements taken while the preschool child performs the activities are uploaded to a computer server for analysis. Reports and recommendations are generated by the by the software on the computer for parents. The reports are based on the preschool child's activities performed (type of activity, number of attempts, duration, percentages of correct/incorrect answers). The recommendations include activities and products that are associated with improving performance in areas of weakness identified in the preschool child's development.

In U.S. Pat. Pub. No. 2008/0187893, a system is proposed that provides for recording of early childhood behaviors for assessment, assessment of master of behaviors, and play activity planning. The assessment is used to estimate the developmental progress of the preschool child, analyze developmental progress, and send data suggesting one or more activities for the preschool child to the parents. The suggestions are based on the developmental progress of the preschool child.

In U.S. Pat. Pub. No. 2012/0122066, a system is proposed that provides a system with child interactive software for producing an online interactive environment for learning. The system is configured so that a preschool child may interact with a device executing the software rather than a person. The activities presented to a child between the ages of 1 and 10 by the software so as to provide measurable play for the preschool child. Parents are informed as to which activities remain incomplete or with incorrect answers. The software is executed by a computer processor and is configured to interface with a central server.

The above discussed U.S. Pat. Pubs. 2012/0329025, 2009/0094540, 2008/0187893, and 2012/0122066 are hereby incorporated by reference for all purposes in their entirety.

A shortcoming of the systems described above is that none of the prior art proposes a method of scoring early childhood developmental activities to indicate the relative benefits of each of the activities to the preschool child's development. While U.S. Pat. Pub. No 2012/0329025 proposes a system configured to identify developmental areas where a preschool child is not performing up to expectations; U.S. Pat. Pub. No. 2009/0094540 proposes a system configured to produce a list of recommended activities and products for improving performance of a preschool child, U.S. Pat. Pub. No. 2008/0187893 proposes a system configured to suggest a list of activities based on developmental progress, U.S. Pat. Pub. No. 2012/0122066 proposes a system configured to present activities to children ages 1 to 10 in an interactive environment and to inform mentors of the activities that remain incomplete. Therefore, a need exists for a method and system that provides a score for activities directed to enhancing early childhood development so that caregivers are informed of a recommended value that each of the activities is likely to have for their preschool child's development.

### BRIEF SUMMARY OF THE DISCLOSURE

In aspects, the present disclosure is related to early childhood development. Specifically, the present disclosure is related to evaluating child development activities.

One embodiment includes a method of evaluating child development activities for a preschool child, the method comprising the steps of: scoring one or more child development activities based on a target age and one or more received responses to questions pertaining to performance of one or more child developmental milestones by the preschool child, wherein the one or more received responses comprise: incompletion status information for the one or more child developmental milestones, each having an associated child development milestone age, and wherein each child developmental milestone is associated with one or more child development activities, each of which has an associated activity age.

The method may also include the steps of: receiving the responses to the questions; and retrieving data on the target age of the preschool child. The method may also include the step of: prompting a caregiver to respond to the questions. The method may include the steps of: ranking the one or more child development activities based on the one or more scores; and communicating the ranked one or more child development activities to the caregiver, wherein the step of communicating is performed by displaying the ranked one or more child development activities.

The step of scoring may include substeps of: estimating a difference between the target age and the activity age for each of the one or more child development activities; applying an activity age difference weighting factor to each of the activity age differences; estimating an average difference between the target age and the milestone age for each of the one or more child developmental milestones associated with each of the one or more one child development activities; applying an average milestone age difference weighting factor to each of the average milestone age differences; estimating an incompletion average for each of the one or more milestones associated with each of the one or more one child development activities; applying a milestone incompletion weighting factor to the incompletion average for each one or more activities; and combining the weighted activity age difference, the weighted average milestone age difference, and the weighted incompletion average. The step of scoring may also include substeps of: selecting the activity age difference weighting factor; selecting an average milestone age difference weighting factor; and selecting the milestone incompletion weighting factor. At least one of the weighting factors may be different than at least one other of the weighting factors. The scoring steps may include the equation:

$$Activity Score = ( \frac{{T}_{A} - \vert {T}_{A} - {A}_{A} \vert}{{T}_{A}} * {W}_{A} ) + ( \frac{{T}_{A} - \vert {T}_{A} - {M}_{Aavg} \vert}{{T}_{A}} * {W}_{Mavg} ) + ( {M}_{Iavg} * {W}_{I} )$$

wherein T_{A} is the target age, A_{A} is the activity age, W_{A} is the activity weighting factor, M_{Aavg} is the milestone age average for counted milestones, W_{Mavg} is the milestone average weighting factor, M_{Iavg} is the incompletion average for the milestones, and W_{I} is the milestone incompletion weighting factor. The target may be a chronological age or an estimated developmental age of a preschool child. The scoring step may yield a numerical value for each child development activity. The processor may be disposed on a client platform, which may be a personal computer or mobile computing device, such as a computer tablet or smartphone.

The child developmental milestones may each be associated with at least one child development area. The child development areas may include one or more of: cognitive skills, linguistic skills, social/emotional skills, and physical skills. The method may further include the steps of: receiving a request for information pertaining to child development; and providing access to at least one information resource based on the request for information. The at least one information resource may include at least one of: an image file, a video file, and an audio file.

Another embodiment includes a method of evaluating child development activities for a preschool child, the method comprising the steps of: scoring a preschool child development activity based on the target age and one or more received responses to questions pertaining to performance of one or more child developmental milestones by the preschool child, wherein the one or more received responses comprise: incompletion status information for the one or more child developmental milestones, each having an associated child development milestone age, and wherein each child developmental milestone is associated with one or more child development activities, each of which has an associated activity age.

Another embodiment includes a method of evaluating child development activities for a preschool child, the method comprising the step of: scoring one or more preschool child development activities based on the target age and one or more received responses to questions pertaining to performance of one or more child developmental milestones by the preschool child, wherein the one or more received responses comprise: incompletion status information for the one or more child developmental milestones, each having an associated child development milestone age, and wherein each child developmental milestone is associated with one or more child development activities, each of which has an associated activity age; and wherein the scoring step uses the equation:

$$Activity Score = ( \frac{{T}_{A} - \vert {T}_{A} - {A}_{A} \vert}{{T}_{A}} * {W}_{A} ) + ( \frac{{T}_{A} - \vert {T}_{A} - {M}_{Aavg} \vert}{{T}_{A}} * {W}_{Mavg} ) + ( {M}_{Iavg} * {W}_{I} )$$

wherein T_{A} is the target age, A_{A} is the activity age, W_{A} is the activity age difference weighting factor, M_{Aavg} is the average milestone age for counted milestones, W_{Mavg} is the milestone average weighting factor, M_{Iavg} is the incompletion average for the milestones, and W_{I} is the incompletion average weighting factor.

The method may also include the steps of: receiving the responses to the questions; and retrieving data on the target age of the preschool child. The method may also include the step of: prompting a caregiver to respond to the questions. The method may include the steps of: ranking the one or more child development activities based on the one or more scores; and communicating the ranked one or more child development activities to the caregiver, wherein the step of communicating is performed by displaying the ranked one or more child development activities.

The step of scoring may include the substeps of: selecting the activity age difference weighting factor; selecting an average milestone age difference weighting factor; and selecting the incompletion average weighting factor. The weighting factors may identical or at least one of the weighting factors is different than at least one other of the weighting factors. The target age may be a chronological age or an estimated developmental age for a preschool child. The scoring step may yield a numerical value for each child development activity. The processor may be disposed on a client platform, which may be a personal computer or mobile computing device, such as a computer tablet or smartphone.

The child developmental milestones may each be associated with at least one child development area. The child development areas may include one or more of cognitive skills, linguistic skills, social/emotional skills, and physical skills. The method may further include the steps of: receiving a request for information pertaining to child development; and providing access to at least one information resource based on the request for information. The at least one information resource may include at least one of: an image file, a video file, and an audio file.

Another embodiment includes a method of indicating progress in child development, the method comprising: comparing scores of one or more child development activities for a preschool child at a first time with scores of the one or more child development activities at a second time, wherein the scores at each of the first time and the second time are estimated based on a target age and incompletion status of child developmental milestones associated with the one or more child development activities. The method may also include the steps of: scoring the one or more child development activities at the first time; and scoring the one or more child development activities at the second time. The method may further include a step of ranking the one or more child development activities based on a change in score between the first time and the second time. The method may include steps of: ranking the one or more child development activities based on their scores at the first time; and ranking the one or more child development activities based on their scores at the first time. The method may include step of: ranking the one or more child development activities based on a change in rank between the first time and the second time.

The scoring step may use the equation:

$$Activity Score = ( \frac{{T}_{A} - \vert {T}_{A} - {A}_{A} \vert}{{T}_{A}} * {W}_{A} ) + ( \frac{{T}_{A} - \vert {T}_{A} - {M}_{Aavg} \vert}{{T}_{A}} * {W}_{Mavg} ) + ( {M}_{Cavg} * {W}_{C} )$$

wherein T_{A} is the target age, A_{A} is the activity age, W_{A} is the activity age difference weighting factor, M_{Aavg} is the average milestone age for counted milestones, W_{Mavg} is the milestone average weighting factor, M_{Cavg} is the incompletion average for the milestones, and W_{C} is the milestone incompletion average weighting factor.

Another embodiment includes a non-transitory computer-readable medium product, the medium containing instructions thereon that, when executed by a processor, executes a method, the method comprising the step of: scoring one or more child development activities based on a target age of a preschool child and one or more received responses to questions pertaining to performance of one or more child developmental milestones by the preschool child, wherein the one or more received responses comprise: incompletion status information for the one or more child developmental milestones, each having an associated child development milestone age, and wherein each child developmental milestone is associated with one or more child development activities, each of which has an associated activity age. The medium may include one or more of: i) a ROM, ii) an EPROM, iii) an EEPROM, iv) a flash memory, v) an optical disk, and vi) a hard drive.

Examples of the more important features of the disclosure have been summarized rather broadly in order that the detailed description thereof that follows may be better understood and in order that the contributions they represent to the art may be appreciated. There are, of course, additional features of the disclosure that will be described hereinafter and which will form the subject of the claims appended hereto.

### BRIEF DESCRIPTION OF THE DRAWINGS

For a detailed understanding, reference should be made to the following detailed description of the embodiments, taken in conjunction with the accompanying drawings, in which like elements have been given like numerals, wherein:

FIG. 1 is a flow chart of one embodiment of a method for scoring child development activities at a first time;

FIG. 2 is a flow chart of a detailed scoring step of FIG. 1 with predetermined weighting factors;

FIG. 3 is a flow chart of a detailed scoring step of FIG. 1 with configurable weighting factors;

FIG. 4 is a flow chart of an embodiment of a method for determining child development progress;

FIG. 5 is a graphic of an embodiment of early childhood development milestones organized by time range and development areas;

FIG. 6 is a close up graphic of a set of early childhood development milestones and activities showing chronological and developmental age lines for an exemplary program;

FIG. 7 is a close up graphic of a set of early childhood development milestones and activities with developmental age lines for each developmental area of the exemplary program;

FIG. 8 is a close up graphic of a set of early childhood development milestones and activities where activities may span developmental areas;

FIG. 9 is a dataflow diagram for an embodiment of system for implementing the methods of FIGS. 1-4; and

FIG. 10 is a flow chart of data operations performed using the system of FIG. 9.

### DETAILED DESCRIPTION OF THE DISCLOSURE

In aspects, the present disclosure is related to early childhood development. Specifically, the present disclosure is related to providing direction to caregivers to enhance early childhood development by scoring child development activities based on a child's developmental level and/or age. The present invention is susceptible to embodiments of different forms. There are shown in the drawings, and herein will be described in detail, specific embodiments with the understanding that the present invention is to be considered an exemplification of the principles and is not intended to limit the present invention to that illustrated and described herein.

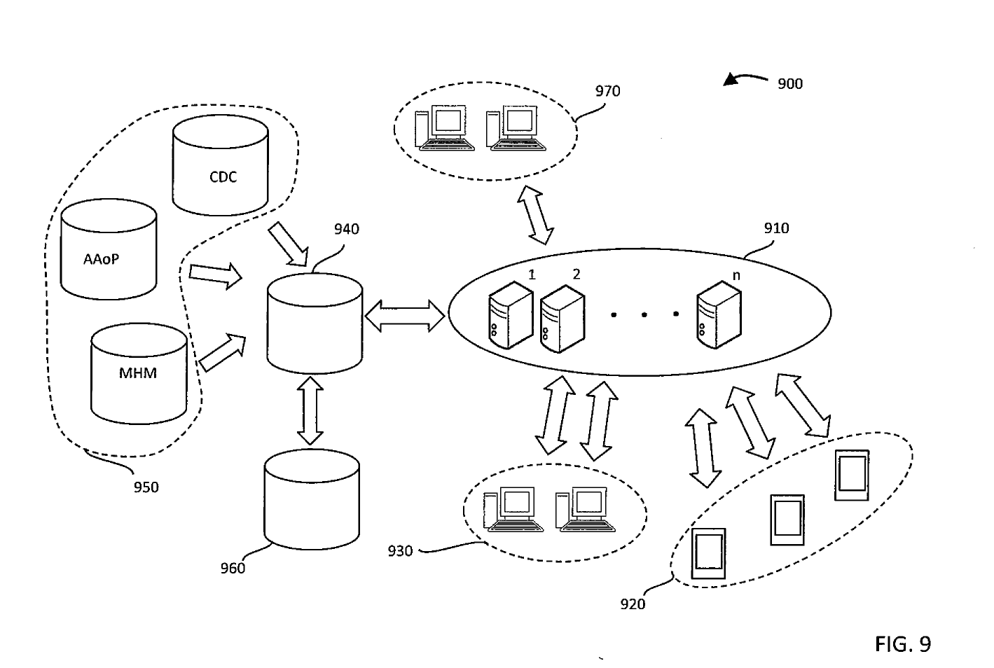

Children may be observed or otherwise evaluated to determine their abilities to perform activities or demonstrate behaviors that are indicative of their developmental level. Each preschool child may have an account comprising records of their background and past performance stored on one or more servers 910 (see FIG. 9). The one or more servers 910 interact with a client platform 920, 930 (see FIG. 9) that is configured to perform a method for scoring child development activities based on a set of responses to questions that pertain to performance of one or more activities or behaviors by the preschool child.

### DEFINITIONS

Herein, embodiments of the method may use the following defined terms:

Caregiver: a person participating in the development of the preschool child either as an observer or person providing stimulus and/or interaction with the preschool child, such as a parent, guardian, child development professional, etc.
Child Development Activity: an activity designed to stimulate educational development in a child and to be performed by the preschool child with or without the caregiver. Each child development activity has an associated age which is a measure of when a normally maturing preschool child is expected to be able to perform the activity. All child development activities are associated with at least one child developmental milestone.
Child Development Activity Recommendation: a list including at least one recommended child development activity. The list may be a subset of a larger list of possible child development activities. The list may be ranked or unranked, and the list may include one or more child development activities directed to a selected purpose in the preschool child's development.
Child developmental milestone: a demarcation of a significant change or stage in development of a child. Milestones may have variations, including parent milestones, descendant milestones, counted milestones, and uncounted milestones. A milestone may have one of three values indicating their use in scoring: i) accomplished (complete), ii) unaccomplished (incomplete), and iii) uncounted (not used in scoring). Each child developmental milestone has an associated age which is a measure of when a normally maturing preschool child is expected to be able to complete the child developmental milestone.
Parent Milestone: A child developmental milestone that includes subordinate milestones. A parent milestone includes one or more descendant milestones. Depending on the embodiment, a parent milestone may receive i) part of its score from associated descendant milestones, ii) all of its score from associated descendant milestones, or iii) an incomplete (“0”) status until all associated descendant milestones are complete, at which point it will be complete (“1”).
Descendant Milestone: A child developmental milestone subordinate to a parent milestone and representing a fractional achievement of a parent milestone.
Counted Milestone: A child developmental milestone that is used (“counted”) in the scoring process.
Uncounted Milestones: A child developmental milestone that is not used (“not counted”) in the scoring process. Uncounted milestones may not be associated with a specific activity or information on the incompletion status of the child developmental milestone may be insufficient.
Performance Gap: A gap between actual performance of the preschool child and performance expected based on the child's target age.
Target Age: A representation of age of the child used for determining the performance gap. Target age may be chronological or developmental.
Chronological Age: The actual age of the child.
Developmental Age: An estimated age of the child based on some developmental analysis or professional assessment of the child.
Developmental Profile: A set of one or more developmental activities and their associated child development milestones that are used to measure the developmental progress of a child. Each of the activities and milestones include an expected age at which the preschool child should be able to complete the milestones/perform the activity.
Milestone Completion Average: a measure of achievement of child developmental milestones used in estimating progress. Child developmental milestones generally receive a score of “0” or “1” based on completion status. The higher the completion status, the higher the score. The milestone completion average ranges from “0” to “1”, as does the milestone completion of a parent milestone.
Milestone Incompletion Average: a measure of lack of achievement of child developmental milestones used in the scoring of child developmental activities and equal to the inverse of milestone completion (1-milestone completion score). Thus a milestone completion average of 0.55 would correspond to a milestone incompletion average of 0.45.

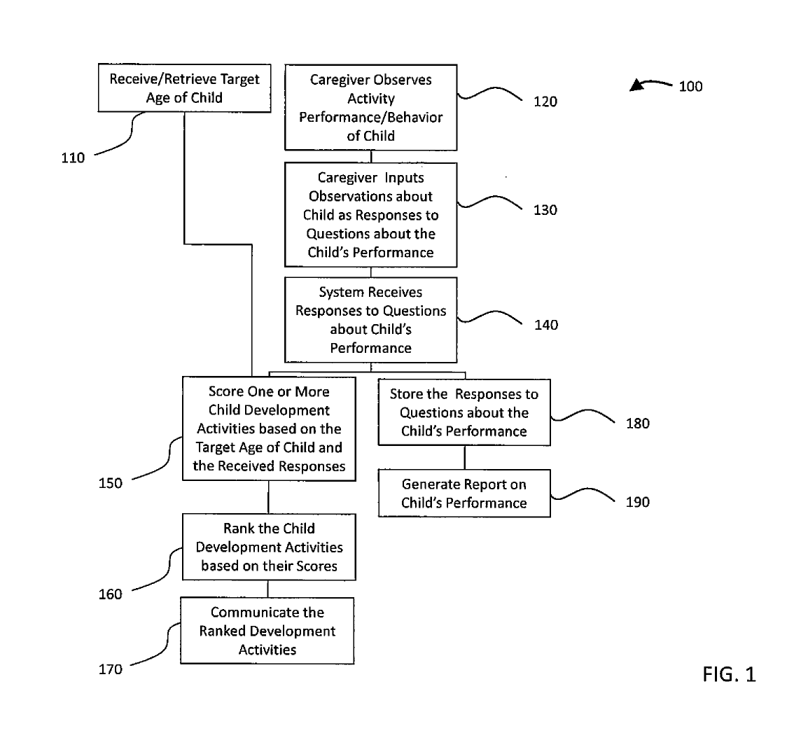

FIG. 1 shows a flow chart of a method of 100 for scoring child development activities. In step 110, a target age of a child is received or retrieved by a computer processor running a client software application. The client software application may be running on a client platform 920, 930, such as a mobile computing device 920 (computer tablet, smartphone, etc.) or a personal computer 930 (desktop or laptop). In step 120, a caregiver observes behavior or activity performance in a preschool child. In step 130, the caregiver inputs observations about the behavior or activity performance as responses to questions generated by the client software application. In step 140, the responses are received by client device. The responses determine whether there is sufficient information about a child developmental milestone for it to be a counted milestone. Insufficient data will result in the child developmental milestone being classified as an uncounted milestone, which will not be treated as either complete or incomplete for scoring purposes. In step 150, one or more scores may be estimated for one or more child development activities based on the responses received on the client device, the child's target age, and at least one development profile. In step 160, the one or more child development activities may be ranked according to their scores. In step 170, the ranked child development activities may be communicated to the caregiver. This communication may be via a display on the client platform 920, push notifications to the client platform 920 or another communication device, e-mail, web portal, push notifications, and other communication mechanisms understood to a person of ordinary skill in the art. In some embodiments, the communication may include a child development activity recommendation. The child development activity recommendation may include an exhaustive or limited list of child development activities customized and scored for the preschool child. The ranked child development activities communicated may include up to the entire list of child development activities; however, an abbreviated version may also be provided, such as a top 20 or top 10 ranked activities (overall or in one more specific development areas). In step 180, the received responses may be stored in a database. In step 190, a report may be generated to present information about or related to the received responses to the caregiver.

In some embodiments, step 150 may use an equation for the scoring step. One exemplary equation for scoring is as follows:

$$Activity Score = ( \frac{{T}_{A} - \vert {T}_{A} - {A}_{A} \vert}{{T}_{A}} * {W}_{A} ) + ( \frac{{T}_{A} - \vert {T}_{A} - {M}_{Aavg} \vert}{{T}_{A}} * {W}_{Mavg} ) + ( {M}_{Iavg} * {W}_{I} )$$

wherein T_{A} is the target age, A_{A} is the activity age, W_{A} is the activity weighting factor, M_{Aavg} is the milestone age average for counted milestones, W_{Mavg} is the milestone average weighting factor, M_{Iavg} is the incompletion average for the milestones, and W_{I} is the milestone incompletion weighting factor.

Another exemplary equation for scoring is as follows:

$$Activity Score = ( \frac{{T}_{A} - \vert {T}_{A} - {A}_{A} \vert}{{T}_{A}} * 100 * {W}_{A} ) + ( \frac{{T}_{A} - \vert {T}_{A} - {M}_{Aavg} \vert}{{T}_{A}} * 100 * {W}_{Mavg} ) + ( {M}_{Iavg} * 100 * {W}_{I} )$$

wherein T_{A} is the target age, A_{A} is the activity age, W_{A} is the activity weighting factor, M_{Aavg} is the milestone age average for counted milestones, W_{Mavg} is the milestone average weighting factor, M_{Iavg} is the incompletion average for the milestones, and W_{I} is the milestone incompletion weighting factor.

Still another exemplary equation for scoring is as follows:

$$Activity Score = ( \frac{{T}_{A} - \vert {T}_{A} - {M}_{Aavg} \vert}{{T}_{A}} * {W}_{Mavg} ) + ( {M}_{Iavg} * {W}_{I} )$$

wherein M_{Aavg} is the milestone age average for counted milestones, W_{Mavg} is the milestone average weighting factor, M_{Iavg} is the incompletion average for the milestones, and W_{I} is the milestone incompletion weighting factor.

In some embodiments, one or more of the weighting factors may be modified based on a characteristic of the child developmental milestone or the child development activity. The system 900 may allow the caregiver to select (at the one or more servers 910 or the client platform 920, 930) a “focus” or “goal” for the development of the preschool child. Child developmental milestones related to these goals may be associated with activities, forming a “goal universe” of activities. The child development activities in the goal universe may receive a score increase due to additional weighting of the activity age weighting and/or additional weighting of the milestone age average weighting for milestones associated with the activities in the goal universe.

For example, if a caregiver decided to place additional emphasis on the cognitive developmental area than the other developmental areas, then the scoring of child development activities associated with cognitive milestones may receive an increase in one or more of the weighting factors. This additional emphasis may result in activities associated with cognitive development to receive higher scores than activities in other developmental areas would receive under similar circumstances.

In some embodiments, the caregiver may have the option to select and/or display activities solely from the goal universe. Here, the scoring and subsequent ranking may, optionally, only be performed on activities within the goal universe.

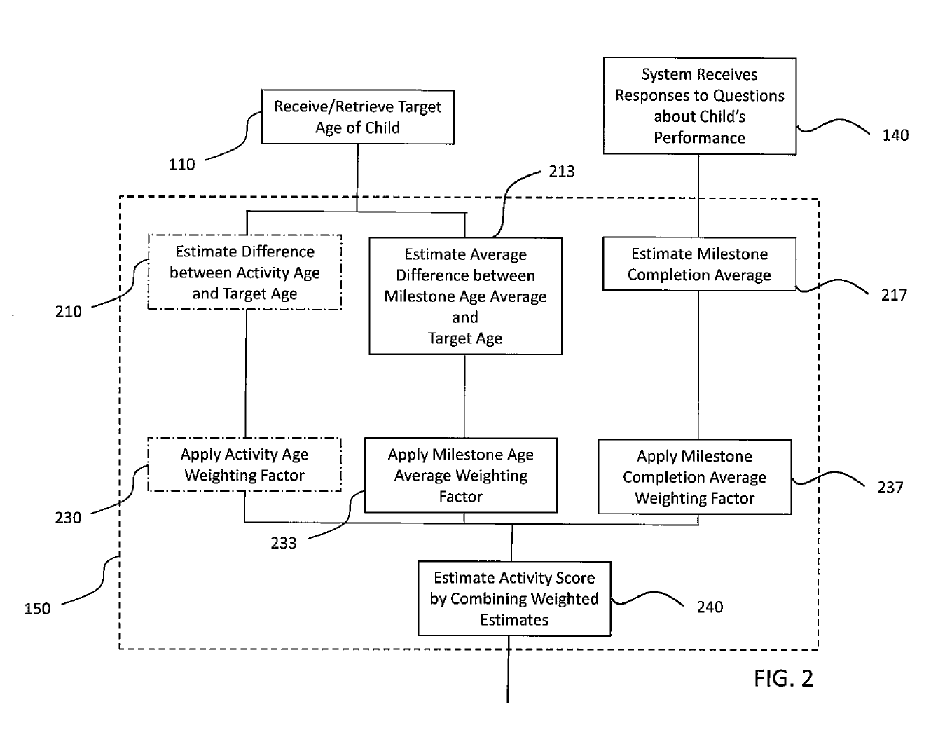

FIG. 2 shows a flow chart of one embodiment of the scoring step 150 from FIG. 1. In step 210, the target age information received/retrieved in step 110 may be used to determine a difference (activity age difference) between a target age and the activity age associated with a child development activity. The activity age difference may be expressed as, but is not limited to, a numerical difference between the age of the activity and the target age or a fractional difference between the activity age and target age. In some embodiments, the activity age difference may be a proximity (an absolute value) distance between the activity age and the target age. In other embodiments, the activity age difference may be a numerical difference (positive or negative) between the activity age and the target age. In step 230, a weighting factor may be applied to the activity age difference.

In step 213, the target age information received/retrieved in step 110 may be used to determine a difference (milestone age difference) between a target age and the milestone age associated with a child developmental milestone. The milestone age difference may be expressed as, but is not limited to, a numerical difference between the age of the milestone and the target age or a fractional difference between the milestone age and target age. In some embodiments, the milestone age difference may be a proximity (an absolute value) distance between the milestone age and the target age. In other embodiments, the milestone age difference may be a numerical difference (positive or negative) between the milestone age and the target age.

If there are two or more counted milestones associated with the same activity, then each milestone age difference may be estimated and then the values averaged to determine the average milestone age difference. If there is only one milestone associated with the activity, then the average milestone age difference will be equal to the value of the one milestone age difference. In some embodiments, a milestone associated with an activity may be an uncounted milestone, and uncounted milestones may not be used in estimating the average milestone age difference. In step 233, a weighting factor may be applied to the average milestone age difference.

In step 217, the received responses from step 140 are used to determine whether child developmental milestone(s) associated with the child development activity have been completed. If multiple child developmental milestones are associated with the child development activity, then the milestone incompletion value is averaged. If the child development activity has a single milestone, then the milestone incompletion average values will be either a “1” (incomplete) or a “0” if complete. In some embodiments, a milestone may be dropped out of the calculation with a status equivalent to “not counted” or “uncounted” which is associated with a failure to receive a response related to that milestone. In step 237, a weighting factor may be applied to the milestone incompletion average.

In step 240, the weighted activity age difference, the weighted average milestone age difference, and weighted average milestone incompletion may be combined to form an estimated activity score. In some embodiments, the application of one or more of the weighting factors (steps 230, 233, 237) may be optional.

In some embodiments, the scoring step 150 may be performed based on child developmental milestones only. When using only child developmental milestones and the target age to determine child development activity age scores, steps 210 and 230 are not performed.

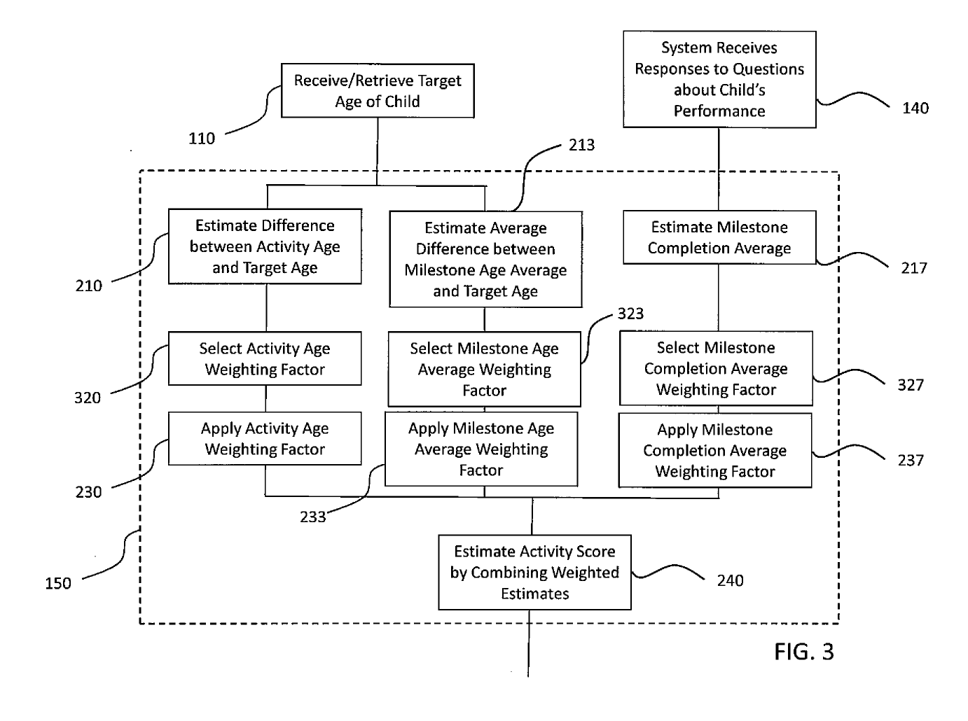

FIG. 3 shows a flow chart of another embodiment of step 150. After steps 210, 213, and 217, respectively, and before steps 230, 233, and 237, respectively, the weighting factors may be selected. In step 320, the activity weighting factor is selected. The activity weighting factor may directly selected or indirectly selected. If indirectly selected, then a value may be assigned based on response to one or more questions, wherein the weighting factor is selected based at least partially on the one or more responses. The activity weighting factor may be selected directly by the caregiver, indirectly through responses by the caregiver, or by the system. Similarly, in steps 323 and 327, the average milestone weighting factor and the milestone incompletion average weighting factor may be selected. If only child developmental milestone information is used to estimate the activity score, then steps 210, 320, and 230 may not be performed.

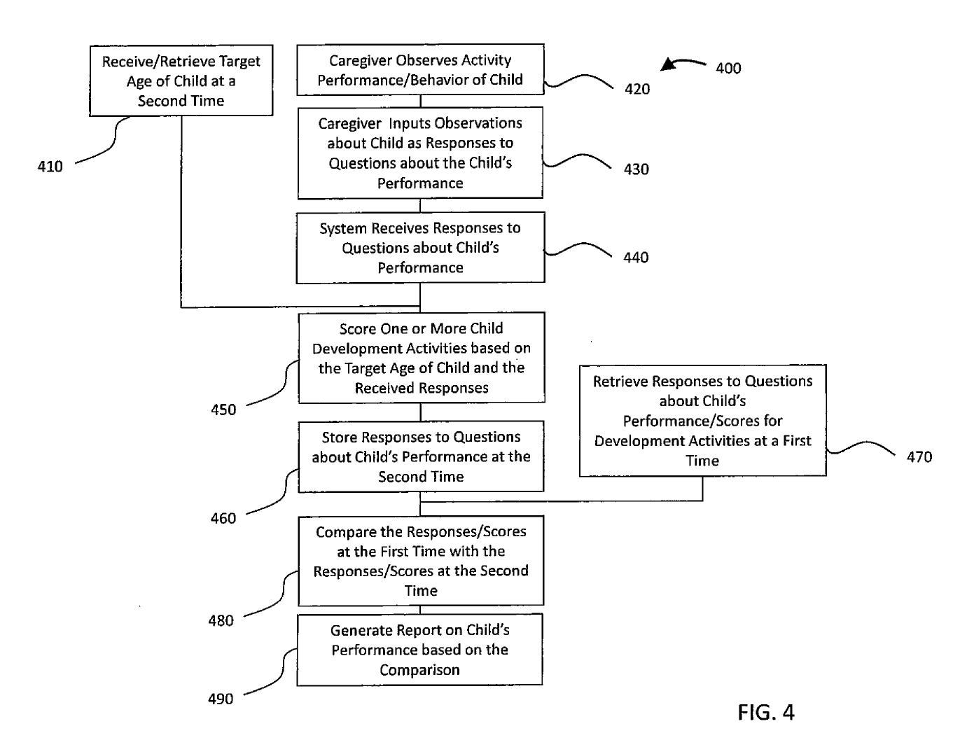

FIG. 4 shows a flow chart of a method 400 for indicating the progress of a child's development using the system. In step 410, information regarding the child's target age at a second point in time is received or retrieved. Steps 420-460 are similar to steps 120-160, though taking place at a second time. In step 420, the caregiver observes behaviors and activity performance of the child. In step 430, the caregiver provides observations about the child's behavior and activity performance into the client software in response to questions generated by the software. Observations, in the form of responses to questions, may be input by the caregiver of an agent or person otherwise authorized by the caregiver. Herein, questions may include any presentation that requires a response from the caregiver, including, but not limited to, interrogatories, blanks to be filled in, displayed icons, prompts, and declaratory statements or words configured to elicit a confirmation. In step 440, the responses to questions (second set) are received at the client platform 920, 930. In step 450, the child development activities are scored based on the second target age and the second set of responses. In step 460, the second set of responses and scores may be stored in the database. In step 470, the first set of responses and/or scores may be retrieved. In step 480, the second set of responses and/or scores may be compared with the first set of responses and/or scores. In step 490, a report indicating the differences between the first set and the second set may be generated. For example, the report may indicate which milestones or activities have changed status between the first and second times. In another non-limiting example, the report may indicate a change in rank or change in score between developmental activities between the first point in time and the second point in time.

Ideally, all questions receive responses at both the second time (step 440) and the first time (retrieved in step 470); however, this may not be the case. In the event that information is insufficient about one or more child developmental milestones at either of the first and second times, the report may include a listing of the child developmental milestones that were not used in the scoring of child development activities. In some circumstances, the insufficiencies may not be consistent between the first and second times. The report may also, then, include a listing of milestones where information insufficiency was inconsistent.

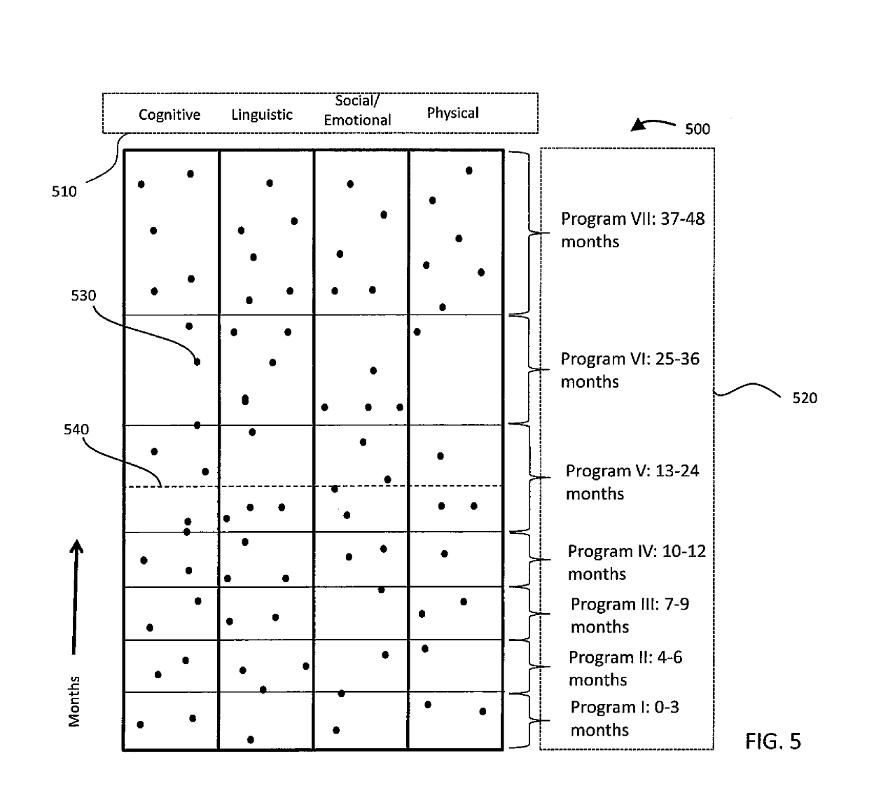

FIG. 5 shows a graphic of the child developmental milestone universe 500. The universe 500 may be divided into developmental areas 510. The use of four developmental areas representing cognitive, linguistic, social/emotional, and physical skills is exemplary and illustrative only, as there may be more or fewer than four developmental areas, and the developmental areas may be divided based on similar or different sets of skills. The universe 500 may also be divided by age into programs 520, such that milestones 530 may be grouped by both developmental area 510 and program 520. It is contemplated that the duration of programs may vary from program to program or overall. The number of programs, as shown, is seven; however, it is contemplated that any number or range of programs may be used to cover the 0-66 month preschool time frame. The dotted line 540 represents the target age of the child; thus milestones 530 above the line 540 have milestone ages greater than the target age of the child and milestones 530 below the line 540 have milestone ages less than the target age of the child.

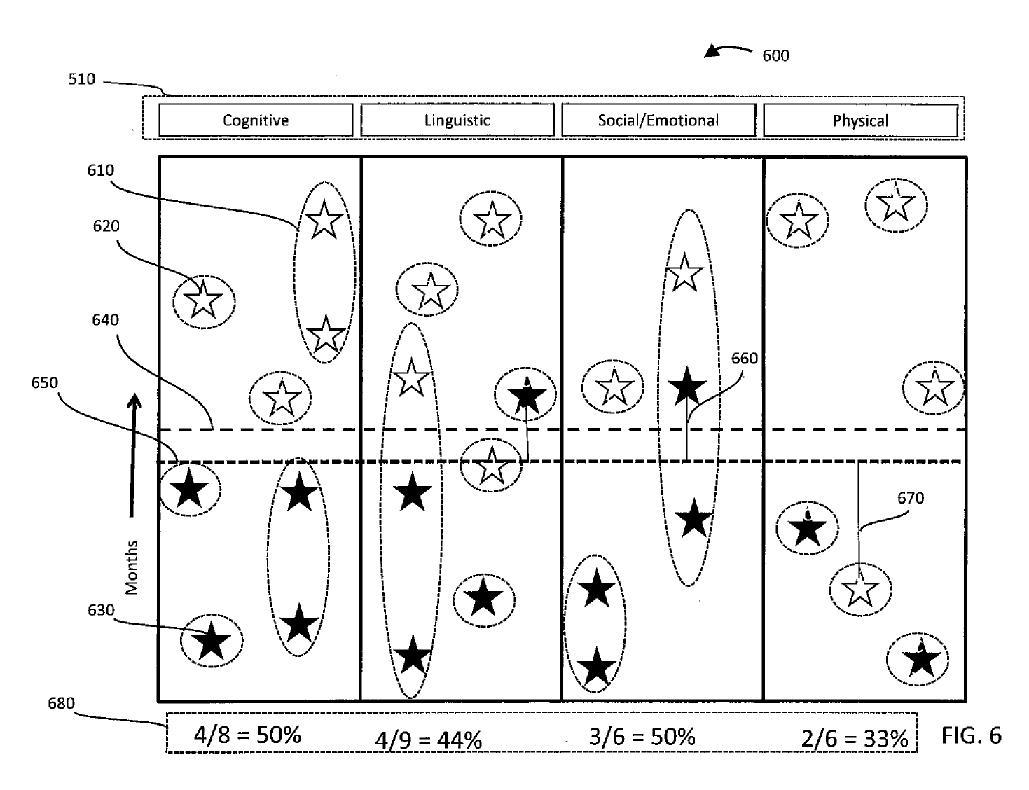

FIG. 6 shows a graphic of an exemplary program 700 of the milestone universe 600 from FIG. 5. Activities 610 are associated with one or more milestones 620, 630. An activity 610 may have a combination of unaccomplished child developmental milestones 620 and accomplished child developmental milestones 630. In FIG. 5, line 540 represented the target age of the child; however, the target age may be a chronological age 640 or a developmental age 650. As shown in FIG. 6, the child's developmental age line 650 is below the chronological age line 640, thus the caregiver responses received by the system may indicate that the child is behind in overall progress relative to the expectations represented by the child developmental milestones.

The developmental age may be determined by the system or stored in the system based on a professional assessment of the child's development. One exemplary and non-limiting way to estimate the developmental age is to estimate a developmental age line 650 that is at the statistical mean between milestones that are unaccomplished and below the line or accomplished and above the line. Line 660 indicates a distance between an accomplished child developmental milestone 630 that was accomplished ahead of the estimated developmental age. Line 670 indicates a distance for an unaccomplished child developmental milestone that is behind relative to the estimated developmental age. Finally, another measure of progress may be a percentage of child developmental milestones completed by developmental area 510 in the program 680.

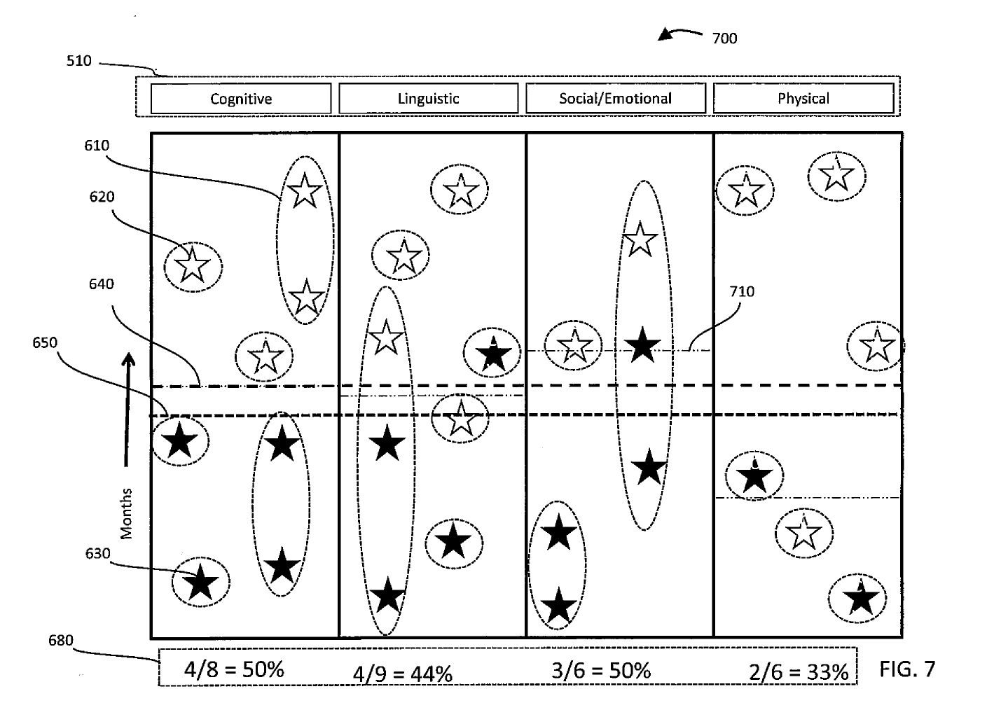

FIG. 7 shows a graphic of an exemplary program 700 where the estimated developmental ages are shown for each developmental area 510 as well as with line 650 for the program 700. Estimated developmental age by area line 710 indicates an estimated developmental age based on the same milestone distance calculation used for line 650; however, the milestones used in the calculation are restricted to each developmental area 510.

For example, as shown, the cognitive skill area has zero accomplished child developmental milestones above the chronological age line 640 and zero unaccomplished child developmental milestones below the chronological age line 640. Thus, so the estimated developmental age for the cognitive skill area may default to the chronological age line 640.

The linguistic skill area has one accomplished child developmental milestone above the chronological age line 640 and one unaccomplished child developmental milestones below the chronological age line 640. Here, the distance below the line of the unaccomplished child developmental milestone may be subtracted from the distance above the line of the accomplished child developmental milestone and then the difference divided by the number of milestones (two). In this example, the calculation results in the linguistic skill area development line being below the chronological age line 640 but above the developmental age line 650.

The social/emotional skill area has one accomplished child developmental milestone above the chronological age line 640 and zero unaccomplished child developmental milestones below the chronological age line 640, thus the social/emotional area developmental age line passes through the only milestone that is accomplished ahead of time. This case, as discussed below, would yield a different result if the raising of the development area developmental age line had resulted in additional milestones being introduced to the computation.

The physical skill area has zero accomplished child developmental milestones above the chronological age line 640 and one unaccomplished child developmental milestone below the chronological age line 640. Unlike the social/emotional case; however, the physical skill area developmental age line being placed at the age of the one unaccomplished child developmental milestone below the chronological age line 640 would result in an accomplished child developmental milestone being introduced to the computation. Thus, recomputation may be performed to after initially placing the developmental area line with the originally identified unaccomplished child developmental milestone. The result, as shown, is a physical developmental area developmental age line that is equidistant (since there were only two milestones in the computation) between one unaccomplished child developmental milestone below the developmental area line and one accomplished child developmental milestone above the developmental area line.

The above computation is merely one, non-limiting way of estimating developmental age. By estimating developmental age across all developmental areas individually and in aggregate, the caregiver may receive a clearer picture of the actual developmental state of the child. In some embodiments, specific milestones, activities, or developmental areas may receive additional weighting based on input from the caregiver.

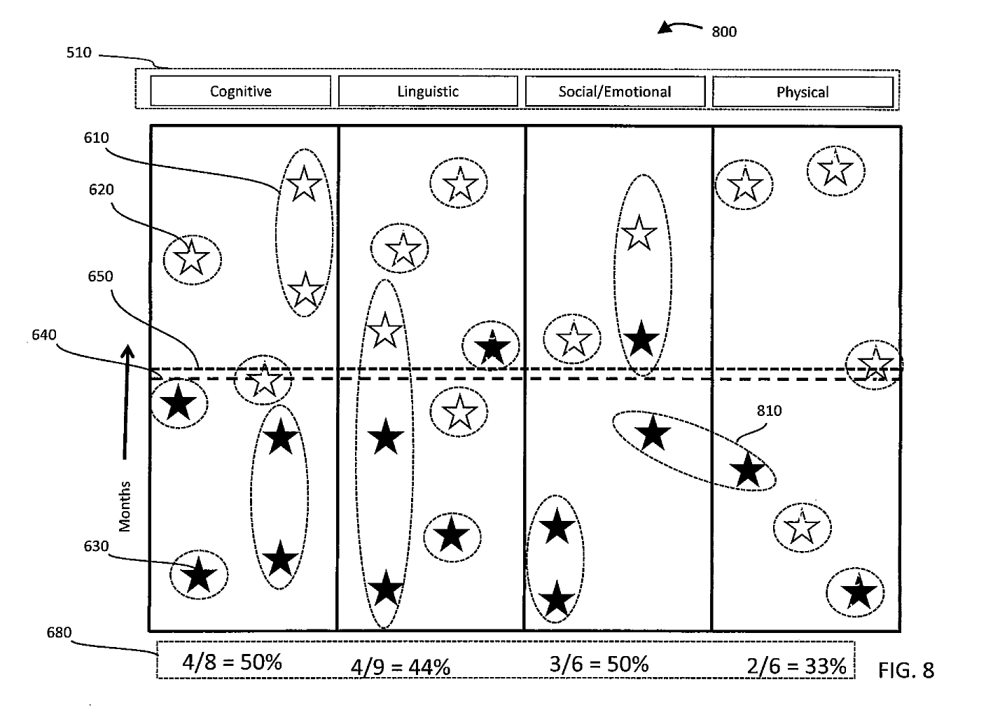

FIG. 8 shows a graphic of an exemplary program 800 wherein activity 810 is shown spanning across two developmental areas (social/emotional and cognitive). The spanning of two developmental areas is exemplary and illustrative only, since an activity may be limited to a single area or span two or more areas up to the total number of developmental areas used. Activities spanning areas may result in shifts in rankings between activities when a caregiver or the system places additional weight on milestones in specific developmental areas or milestones. When specific additional weights are applied to one or more milestones of an activity, then the score for the activity will increase/decrease accordingly, which will make it more/less likely that a milestone not receiving specific additional weight but associated with the activity will be accomplished.

FIG. 9 shows a diagram of a system 900 including one or more servers 910 configured to update and maintain information related to child development activities and child developmental milestones. Where the one or more servers 910 are a plurality of servers, the one or more servers 910 may be configured for serial and/or parallel operation. In some embodiments, the one or more servers 910 may include a load balancing server to coordinate data traffic to others of the one or more servers. The one or more servers 910 are configured to interface with a client platform 920, 930. The client platform 920, 930 may include one or more of: i) a mobile computing device 920 (smartphone, tablet, etc.) and personal computer 930 (desktop, laptop, etc.). The client platform 920, 930 includes at least one processor configured to implement a software program to implement a child development activity selection and scoring program. In some embodiments, the client platform 920, 930 will be the primary device used by the caregiver to receive questions about child behavior and activity performance and for the caregiver to input responses to the questions and requests for reports on progress. The client platform 920, 930 may include a keyboard (physical or virtual) and a display. In some embodiments, the client platform 920, 930 may be configured to receive and/or transmit information audibly.

The client platform 920, 930 includes a non-transitory computer-readable medium that includes instructions that, when executed by the processor, performs a method that includes a step of scoring a child development activity recommendation. The medium be any non-transitory computer storage as would be understood by a person of ordinary skill in the art, including, but not limited to, i) a ROM, ii) an EPROM, iii) an EEPROM, iv) a flash memory, v) an optical disk, and vi) a hard drive. The medium may include removable and/or non-removable media implemented by any method or technology for implementing computer-readable instructions, data structures, program modules or other data. The client platform 920, 930 may be configured to communicate with the one or more servers 910 over any available data communication medium, including, but not limited to, wireless communication (radio frequency, Wi-Fi, cellular, etc.), wired communication, and the Internet.

Information received at the client platform 920, 930 may be transmitted to the one or more servers 910 which are configured to store the information in a database 940. The database 940 may include multiple data storage devices. The database 940 is configured to store and retrieve questions, responses to questions, activities, milestones, support material (such as audio or visual files related to child development), for retrieval by a caregiver using the client platform 920, 930. The information regarding a preschool child may include may include personal information for the preschool child, such as the preschool child's name, date of birth, address, or parent's name, and may also include the current developmental progress or abilities of the preschool child when an account for the child is established on the one or more servers 910. The information may further include information associating the preschool child with a particular group or class, a particular school, a particular school district or educational organization, one of more teachers, one or more school administrators, one or more educational specialists, or one or more parents or guardians.

The database 940 may include offsite storage and backups 960 that are located a multiple physical locations. Similarly, the one or more servers 910 may be mirrored to provide functionality across a wider group of caregivers and redundancy to accommodate system loads, planned maintenance downtime, and unexpected downtime.

The one or more servers 910 and the client platform 920, 930 may also be configured to provide access control of information and privileges for the preschool child's account. The system 900 also includes access to child development data sources 950. The data sources 950 may be maintained by government or professional agencies working in the area of early child development. Information from the data sources 950 may be uploaded into the database 940 either manually or automatically through electronic or non-electronic means. Information from the data sources 950 may be modified or reconciled with existing child development information in the database 940 at the one or more servers 910 prior to downloading to the client platform 920, 930.

In some embodiments, additional information regarding child development activities may be uploaded by child care professionals through computer workstations 970. Administrative adjustments to the system 900 may also be performed through the workstations 970. The information from the workstations 970 may include outputs of complex logical calculations performed by child care professionals or systems administrators and/or instructions modifying of one or more of the weighting factors or milestone-activity relationships.

Generally, the methods may be performed on the client platform 920, 930 even when the client platform 920, 930 is not in communication with the one or more servers 910, though communication with the one or more servers 910 is convenient for receiving updates. In some embodiments, the memory storage on the client platform 920, 930 may include a reduced copy of data from the database 940 for the specific caregiver using the client platform 920, 930.

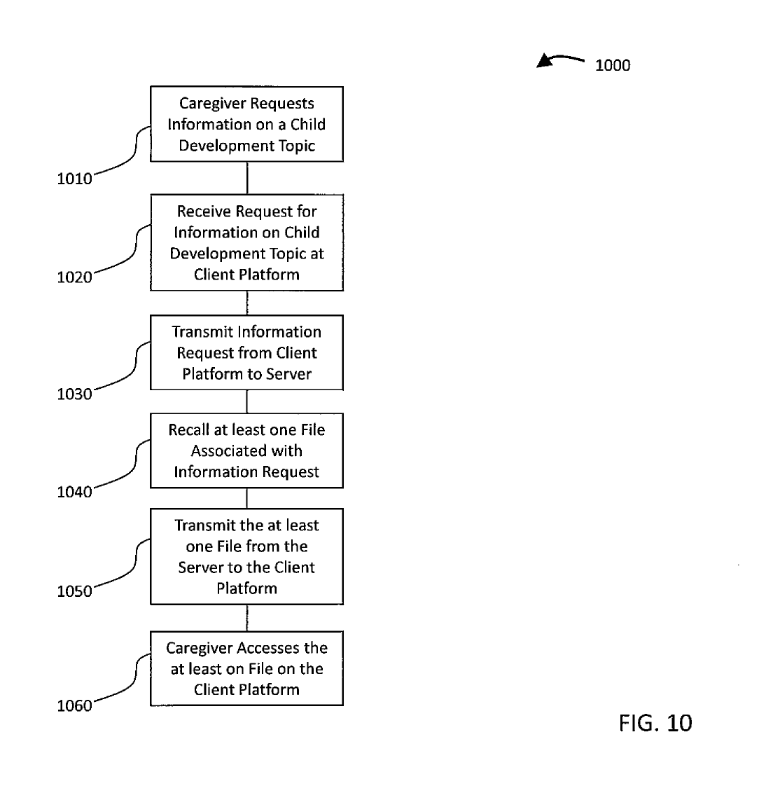

FIG. 10 shows a flow chart of a method 1000 for providing information on a child development topic to a caregiver. In step 1010, the caregiver may request information regarding a child development topic (milestone, activity, development area, program, etc.). In step 1020, the request may be received by the client platform 920. In step 1030, the client platform 920 may transmit the information request to the server 910. In step 1040, the server 910 may recall at least one file associated with the information request. The server 910 may recall the at least one file from itself or the database. In step 1050, the server 910 may transmit the at least one file to the client platform 920. In step 1060, the client platform 920 may provide access to the file to the caregiver. The at least one file may be an image file, a video file, or an audio file. In some embodiments, the file may include text, a hyperlink, or other means to direct the caregiver to additional information on the requested information topic.

While the invention has been described with reference to exemplary embodiments, it will be understood that various changes may be made and equivalents may be substituted for elements thereof without departing from the scope of the invention. In addition, many modifications will be appreciated to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method of evaluating child development activities for a preschool child, the method comprising the steps of:
scoring a preschool child development activity based on the target age and one or more received responses to questions pertaining to performance of one or more child developmental milestones by the preschool child using a processor,
wherein the one or more received responses comprise:
incompletion status information for the one or more child developmental milestones, each having an associated child development milestone age, and wherein each child developmental milestone is associated with one or more child development activities, each of which has an associated activity age.

2. The method of claim 1, further comprising the steps of:
receiving the responses to the questions; and
retrieving data on the target age of the preschool child.

3. The method of claim 2, further comprising the step of:
prompting a caregiver to respond to the questions.

4. The method of claim 1, further comprising the steps of:
ranking the child development activity based on the score; and
communicating the ranked child development activity to the caregiver.

5. The method of claim 4, wherein the step of communicating is performed by displaying the ranked one or more child development activities.

6. The method of claim 1, wherein the step of scoring comprises the steps of:
estimating a difference between the target age and the activity age;
applying the activity age difference weighting factor to the activity age difference;
estimating an average difference between the target age and the milestone age for each of the one or more child developmental milestones associated with the child development activity;
applying the weighting factor to each of the average milestone age differences;
estimating an incompletion average for each of the one or more milestones associated with the child development activity;
applying the milestone incompletion weighting factor to the incompletion average; and
combining the weighted activity age difference, the weighted average milestone age difference, and the weighted incompletion average;

7. The method of claim 6, wherein the step of scoring further comprises the steps of:
selecting an activity age difference weighting factor;
selecting an average milestone age difference weighting factor; and
selecting a milestone incompletion weighting factor.

8. The method of claim 6, wherein at least one of the weighting factors is different than at least one other of the weighting factors.

9. The method of claim 1, wherein the scoring step comprises using the equation:
$$Activity Score = ( \frac{{T}_{A} - \vert {T}_{A} - {A}_{A} \vert}{{T}_{A}} * {W}_{A} ) + ( \frac{{T}_{A} - \vert {T}_{A} - {M}_{Aavg} \vert}{{T}_{A}} * {W}_{Mavg} ) + ( {M}_{Iavg} * {W}_{I} )$$
wherein T_{A} is the target age, A_{A} is the activity age, W_{A} is the activity weighting factor, M_{Aavg} is the milestone age average for counted milestones, W_{Mavg} is the milestone average weighting factor, M_{Iavg} is the incompletion average for the milestones, and W_{I} is the milestone incompletion weighting factor.

10. The method of claim 1, wherein the target age is a chronological age of the preschool child.

11. The method of claim 1, wherein the target age is an estimated developmental age of the preschool child.

12. The method of claim 1, wherein the score is a numerical value.

13. The method of claim 1, wherein the processor is disposed on a client platform.

14. The method of claim 13, wherein the client platform is a mobile computing device.

15. The method of claim 14, wherein the mobile computing device comprises at least one of: a smartphone and a tablet computer.

16. The method of claim 1, wherein the one or more child developmental milestones are each associated with at least one child development area.

17. The method of claim 16, wherein the at least one child development area comprises at least one of: cognitive skills, linguistic skills, social/emotional skills, and physical skills.

18. The method of claim 16, further comprising:
receiving a request for information pertaining to child development;
providing access to at least one information resource based on the request for information.

19. The method of claim 18, wherein the at least one information resource comprises at least one of: an image file, a video file, and an audio file.

20. A method of evaluating child development activities for a preschool child, the method comprising the step of:
scoring one or more preschool child development activities based on the target age and one or more received responses to questions pertaining to performance of one or more child developmental milestones by the preschool child using a processor,
wherein the one or more received responses comprise:
incompletion status information for the one or more child developmental milestones, each having an associated child development milestone age, and wherein each child developmental milestone is associated with one or more child development activities, each of which has an associated activity age; and
wherein the scoring step uses the equation:
$$Activity Score = ( \frac{{T}_{A} - \vert {T}_{A} - {A}_{A} \vert}{{T}_{A}} * {W}_{A} ) + ( \frac{{T}_{A} - \vert {T}_{A} - {M}_{Aavg} \vert}{{T}_{A}} * {W}_{Mavg} ) + ( {M}_{Iavg} * {W}_{I} )$$
wherein T_{A} is the target age, A_{A} is the activity age, W_{A} is the activity age difference weighting factor, M_{Aavg} is the average milestone age for counted milestones, W_{Mavg} is the milestone average weighting factor, M_{Iavg} is the incompletion average for the milestones, and W_{I} is the milestone incompletion average weighting factor.

21. The method of claim 20, further comprising the steps of:
receiving the responses to the questions; and
retrieving data on the target age of the preschool child.

22. The method of claim 21, further comprising the step of:
prompting a caregiver to respond to the questions.

23. The method of claim 20, further comprising the steps of:
ranking the one or more child development activities based on the one or more scores; and
communicating the ranked one or more child development activities to the caregiver.

24. The method of claim 23, wherein the step of communicating is performed by displaying the ranked one or more child development activities.

25. The method of claim 20, wherein the step of scoring further comprises:
selecting the activity age difference weighting factor;
selecting an average milestone age difference weighting factor; and
selecting the incompletion average weighting factor.

26. The method of claim 20, wherein at least one of the weighting factors is different than at least one other of the weighting factors.

27. The method of claim 20, wherein the target age is a chronological age of the preschool child.

28. The method of claim 20, wherein the target age is an estimated developmental age of the preschool child.

29. The method of claim 20, wherein the score is a numerical value.

30. The method of claim 20, wherein the processor is disposed on a client platform.

31. The method of claim 30, wherein the client platform is a mobile computing device.

32. The method of claim 31, wherein the mobile computing device comprises at least one of: a smartphone and a tablet computer.

33. The method of claim 20, wherein the one or more child developmental milestones are each associated with at least one child development area.

34. The method of claim 33, wherein the at least one child development area comprises at least one of: cognitive skills, linguistic skills, social/emotional skills, and physical skills.

35. The method of claim 20, further comprising:
receiving a request for information pertaining to child development;
providing access to at least one information resource based on the request for information.

36. The method of claim 35, wherein the at least one information resource comprises at least one of: an image file, a video file, and an audio file.

37. A method of indicating progress in child development, the method comprising:
comparing scores of one or more child development activities for a preschool child at a first time with scores of the one or more child development activities at a second time, wherein the scores at each of the first time and the second time are estimated based on a target age and incompletion status of child developmental milestones associated with the one or more child development activities.

38. The method of claim 37, further comprising:
scoring the one or more child development activities at the first time; and
scoring the one or more child development activities at the second time.

39. The method of claim 38, further comprising:
ranking the one or more child development activities based on a change in score between the first time and the second time.

40. The method claim 38, further comprising:
ranking the one or more child development activities based on their scores at the first time; and
ranking the one or more child development activities based on their scores at the first time.

41. The method of claim 40, further comprising:
ranking the one or more child development activities based on a change in rank between the first time and the second time.

42. The method of claim 38, wherein the scoring for the first time and the second time use the equation:
$$Activity Score = ( \frac{{T}_{A} - \vert {T}_{A} - {A}_{A} \vert}{{T}_{A}} * {W}_{A} ) + ( \frac{{T}_{A} - \vert {T}_{A} - {M}_{Aavg} \vert}{{T}_{A}} * {W}_{Mavg} ) + ( {M}_{Cavg} * {W}_{C} )$$
wherein T_{A} is the target age, A_{A} is the activity age, W_{A} is the activity age difference weighting factor, M_{Aavg} is the average milestone age for counted milestones, W_{Mavg} is the milestone average weighting factor, M_{Cavg} is the incompletion average for the milestones, and W_{C} is the milestone incompletion average weighting factor.

43. A non-transitory computer-readable medium product, the medium containing instructions thereon that, when executed by a processor, executes a method, the method comprising the step of:
scoring one or more child development activities based on a target age of a preschool child and one or more received responses to questions pertaining to performance of one or more child developmental milestones by the preschool child,
wherein the one or more received responses comprise:
incompletion status information for the one or more child developmental milestones, each having an associated child development milestone age, and wherein each child developmental milestone is associated with one or more child development activities, each of which has an associated activity age.

44. The non-transitory computer-readable medium product of claim 43, wherein the medium comprises at least one of: i) a ROM, ii) an EPROM, iii) an EEPROM, iv) a flash memory, v) an optical disk, and vi) a hard drive.
